(19) United States
(12) Patent Application Publication
(10) Pub. No.: US 2020/0090567 A1
(43) Pub. Date: Mar. 19, 2020

(54) TEST METHOD OF IN-CELL TOUCH DISPLAY DEVICE

(71) Applicants: HannStar Display (Nanjing) Corporation, Nanjing (CN); HANNSTAR DISPLAY CORPORATION, Taipei City (TW)

(72) Inventors: Hsing-Ying Lee, Tainan City (TW); Sung-Chun Lin, Tainan City (TW); Jui-Hsin Tsai, Taoyuan City (TW)

(21) Appl. No.: 16/691,563

(22) Filed: Nov. 21, 2019

Related U.S. Application Data
(63) Continuation-in-part of application No. 15/659,643, filed on Jul. 26, 2017.

(30) Foreign Application Priority Data
Mar. 24, 2017 (CN) 201710184892.9

(51) Int. Cl. G09G 3/00; G06F 3/041; G09G 3/3266; G09G 3/3291; G09G 3/36

(52) U.S. Cl. CPC G09G 3/006; G06F 3/0412; G06F 3/04164; G09G 3/3688; G09G 3/3291; G09G 3/3607; G09G 3/3677; G09G 3/3266

(57) ABSTRACT

A test method of an in-cell touch display device includes providing a plurality of first test signals and a plurality of second test signals to the first connection pads and the second connection pads of the in-cell touch display device, respectively. Each of the first connection pads is electrically connected to a corresponding data line of the in-cell touch display device, and each of the second connection pads is electrically connected to a corresponding touch electrode of the in-cell touch display device, and the in-cell touch display device is tested after the first and second test signals are provided to the first and second connection pads.

### CROSS REFERENCE TO RELATED APPLICATIONS

This patent application is a continuation-in-part (CIP) of U.S. patent application Ser. No. 15/659,643 filed on Jul. 26, 2017. The present application is based on and claims priority to U.S. patent application Ser. No. 15/659,643 filed on Jul. 26, 2017, which is incorporated by reference herein.

### BACKGROUND OF THE INVENTION

### 1. Field of the Invention

The present invention relates to a test method of an in-cell touch display device, and more particularly to a test method of an in-cell touch display device for independently testing a touch sensing function and a display function.

### 2. Description of the Prior Art

In the various electronic products, a touch display device has been formed by a display screen with touch components extensively, such that users can directly communicate with the electronic products instead of the conventional input equipment such as keyboard and mouse, so as to decrease the size of the electronic products and improve the convenience of communication between human and machines. Nowadays, the industry is currently committed to developing an in-cell touch display device in which the touch components are disposed in the display panel, so as to achieve the minimization of the touch display device.

However, in the manufacturing process of the in-cell touch display device, defects generated in the manufacturing process can cause the in-cell touch display device to not work properly. Therefore, the in-cell touch display device need to be tested. Currently, shorting bar test method or switching thin film transistor (TFT) test method would be normally performed to the in-cell touch display device for testing, and these methods would be performed with an outer test machine at the same time. But, because these methods need to further dispose testing lines of testing thin film transistors, the load of circuit in the in-cell touch display device would be affected, so as to influence a touch sensing function, a display function and manufacturing cost of the in-cell touch display device, wherein the larger size of the in-cell touch display device is particularly affected. So, a preferable test method of the in-cell touch display device needs to be provided.

### SUMMARY OF THE INVENTION

The technical problem wanting to be solved by the present invention is the testing problem of the in-cell touch display device in the current technology. The present invention solves the technical problem described above by providing an in-cell touch display device having connection pads which are specially designed, and also providing a corresponding test system and corresponding test method.

The present invention provides a test method of an in-cell touch display device including performing a test to the in-cell touch display device according to the present invention, so as to probe the electronic components of the in-cell touch display device and perform the detection of the touch sensing function and the display function.

In order to achieve the objectives described above, the present invention provides a test method of an in-cell touch display device. Firstly, an in-cell touch display device is provided, wherein the in-cell touch display device has a touch display region and a peripheral region, and includes a first substrate, a plurality of scan lines, a plurality of data lines, a plurality of touch electrodes and a plurality of connection pads, the scan lines and the data lines are disposed on the first substrate and situated in the touch display region, the touch electrodes are situated in the touch display region, the connection pads are disposed on the first substrate and situated in the peripheral region, the plurality of connection pads include a plurality of first connection pads and a plurality of second connection pads, each of the first connection pads is electrically connected to a corresponding one of the data lines, and each of the second connection pads is electrically connected to a corresponding one of the touch electrodes. Thereafter, a test of the in-cell touch display device is performed, wherein the test of the in-cell touch display device includes providing a plurality of first test signals to the first connection pads and a plurality of second test signals to the second connection pads.

In order to further resolve the technical problem described above, the present may use the following techniques selectively.

According to the test method of the in-cell touch display device described above, the connection pads may further include a plurality of third connection pads, each of the third connection pads is electrically connected to a corresponding scan line, and the step of performing the test of the in-cell touch display device may further include providing a plurality of third test signals to the third connection pads.

According to the test method of the in-cell touch display device described above, the first test signals may include a plurality of gray-scale signals, and the third test signals may include a plurality of scan signals.

According to the test method of the in-cell touch display device described above, the second test signals may include a plurality of common voltage signals, the first test signals, the third test signals and the common voltage signals may be respectively provided to the data lines, the scan lines and the touch electrodes in a first time period.

According to the test method of the in-cell touch display device described above, the second test signals may further include a plurality of touch driving signals, and the touch driving signals may be provided to the touch electrodes in a second time period.

According to the test method of the in-cell touch display device described above, the first time period and the second time period may be not overlapped.

According to test method of the in-cell touch display device described above, the in-cell touch display device may further include at least one gate driving circuit disposed on the first substrate and situated in the peripheral region, the at least one gate driving circuit may be electrically connected to the scan lines, the connection pads may further include a plurality of fourth connection pads electrically connected to the at least one gate driving circuit, and the step of performing the test of the in-cell touch display device may further include providing a plurality of fourth test signals to the fourth connection pads.

According to the test method of the in-cell touch display device described above, the first test signals may include a plurality of gray-scale signals, the second test signals may include a plurality of touch driving signals, and the fourth test signals may include a plurality of gate driving circuit control signals.

According to the test method of the in-cell touch display device described above, the gate driving circuit control signals may include a start signal and at least one clock signal.

According to the test method of the in-cell touch display device described above, the second test signals may include a plurality of common voltage signals and a plurality of touch driving signals, the first test signals, the fourth test signals and the common voltage signals may be respectively provided to the data lines, the at least one gate driving circuit and the touch electrodes in a first time period, and the touch driving signals may be provided to the touch electrodes in a second time period.

According to the test method of the in-cell touch display device described above, the touch electrodes may serve as common electrodes in the first time period.

According to the test method of the in-cell touch display device described above, the in-cell touch display device further comprises a display medium layer.

According to the test method of the in-cell touch display device described above, the display medium layer may be a liquid crystal layer, an electrophoretic display layer or an organic light emitting layer.

According to the test method of the in-cell touch display device described above, the in-cell touch display device may further include a second substrate, and the touch electrodes may be situated between the first substrate and the display medium layer or between the display medium layer and the second substrate.

According to the test method of the in-cell touch display device described above, the step of performing the test of the in-cell touch display device may further include providing a test system, the test system may include a test plate having a plurality of conductive pins, the test plate is placed on the peripheral region and a portion of the conductive pins are correspondingly set to be in contact with the first connection pads and the second connection pads.

According to the test method of the in-cell touch display device described above, the test plate may have a shape which is L-shaped, U-shaped or a shape of “ [symbol] ”.

According to the test method of the in-cell touch display device described above, the connection pads may further include a plurality of third connection pads, each of the third connection pads may be electrically connected to a corresponding scan line, and another portion of the conductive pins may be correspondingly set to be in contact with the third connection pads in the step of performing the test of the in-cell touch display device.

According to the test method of the in-cell touch display device described above, the in-cell touch display device may further include at least one gate driving circuit, the connection pads may further include a plurality of fourth connection pads, the at least one gate driving circuit may be electrically connected to the scan lines and the fourth connection pads, and another portion of the conductive pins may be correspondingly set to be in contact with the fourth connection pads in the step of performing the test of the in-cell touch display device.

Because the touch sensing function and the display function of the in-cell touch display device would be tested by the test method of the in-cell touch display device according to the present invention, the testing cost and the testing time can be economized. Furthermore, the conductive pins of the test plate of the in-cell touch display device test system are electrically connected to the connection pads of the in-cell touch display device, such that the conductive pins are electrically connected to the corresponding display components and the corresponding touch components. Thus, the display components and the touch components can be tested independently through the in-cell touch display device test system, such that the touch sensing function and the display function can be tested, and cannot be interfered by each other. Moreover, the in-cell touch display device test system according to the present invention provides the test signals the same as output signals of the integrated circuit chip to the in-cell touch display device, such that the touch sensing function and the display function of the in-cell touch display device can be tested by the full contact test method completely. Therefore, it can judge whether the function of the in-cell touch display device is normal or not before electrically connecting the integrated circuit chip to the connection pads.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1a to FIG. 2 are schematic diagrams of a top view of an in-cell touch display device according to a first embodiment of the present invention.

FIG. 3 is a schematic diagram of a cross-sectional view taken along the cross-sectional line A-A′ in FIG. 2.

FIG. 4 is a schematic diagram of an in-cell touch display device test system according to an embodiment of the present invention.

FIG. 5 is a schematic diagram of an in-cell touch display device coupled to an in-cell touch display device test system in the testing of the in-cell touch display device according to an embodiment of the present invention.

FIG. 6 is a schematic diagram of performing the test of an in-cell touch display device according to a first embodiment of the present invention.

FIG. 7 is a schematic diagram of a cross-sectional view performing the test of the in-cell touch display device according to the first embodiment of the present invention.

FIG. 8 is a flowchart of the test method of the in-cell touch display device according to an embodiment of the present invention.

FIG. 9 is a schematic diagram of a top view of an in-cell touch display device according to a variant embodiment of the first embodiment of the present invention.

FIG. 10 is a schematic diagram of a top view of an in-cell touch display device according to a second embodiment of the present invention.

FIG. 11 is a schematic diagram of a top view of an in-cell touch display device according to a third embodiment of the present invention.

FIG. 12 is a schematic diagram of a top view of an in-cell touch display device according to a fourth embodiment of the present invention.

FIG. 13 is a schematic diagram of a top view of an in-cell touch display device according to a variant embodiment of the fourth embodiment of the present invention.

FIG. 14 is a schematic diagram of a top view of an in-cell touch display device according to a fifth embodiment of the present invention.

FIG. 15 is a schematic diagram of an arrangement of the connection pads of the in-cell touch display device according to an embodiment of the present invention.

FIG. 16 is a schematic diagram of the connection pads of the in-cell touch display device according to an embodiment of the present invention.

FIG. 17 and FIG. 18 are schematic diagrams of a top view of an in-cell touch display device according to a sixth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate on the contents and effects to be achieved. It is needed to note that the drawings are simplified schematic, and therefore, the drawings show only the components and combinations associated with the present invention, so as to provide a clearer description of the basic architecture or method of implementation of the present invention. The components would be complex in reality. In addition, in order to explain, the components shown in the drawings of the present invention are not drawn to the actual number, shape, and dimensions, the detail can be adjusted according to the design requirements.

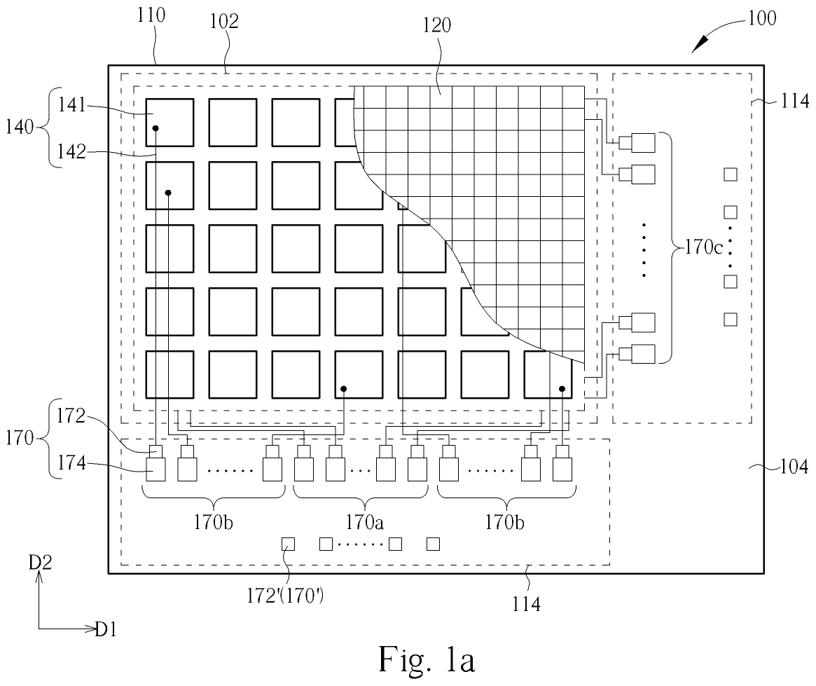

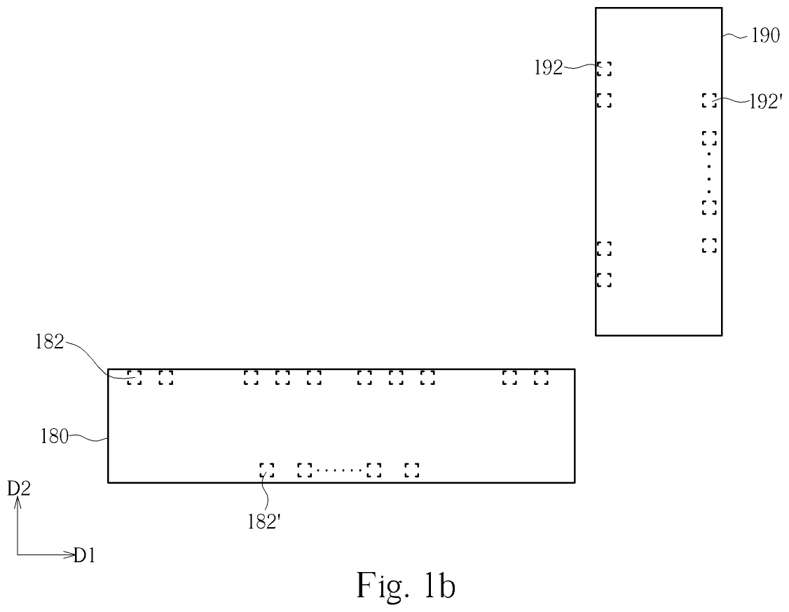

FIG. 1a to FIG. 2 are schematic diagrams of a top view of an in-cell touch display device according to a first embodiment of the present invention, and FIG. 3 is a schematic diagram of a cross-sectional view taken along the cross-sectional line A-A′ in FIG. 2, wherein FIG. 1a is the schematic diagram of the top view of the in-cell touch display device before disposal of an integrated circuit chip and a second substrate, FIG. 1b is the schematic diagram of the top view of the integrated circuit chip of the in-cell touch display device, and FIG. 2 is the schematic diagram of the top view of the in-cell touch display device after disposal of the integrated circuit chip and the second substrate. The in-cell touch display device 100 according to the present invention is a liquid crystal in-cell touch display device for example, but not limited thereto, the in-cell touch display device 100 may be another type of the in-cell touch flat-panel display device, such as an electrophoretic display device or an organic light emitting display device. As shown in FIG. 1a to FIG. 3, the in-cell touch display device 100 according to the first embodiment of the present invention includes a first substrate 110, a second substrate 160, a plurality of display components 120, a plurality of touch components 140, a display medium layer 150, a plurality of connection pads 170 and at least one integrated circuit chip 180. FIG. 1a only illustrates the first substrate 110, a portion of the display components 120, a portion of the touch components 140 and the connection pads 170, FIG. 1b only illustrates the integrated circuit chips 180, 190, and FIG. 2 only illustrates the first substrate 110, the second substrate 160 and the integrated circuit chips 180, 190. As shown in FIG. 3, the first substrate 110 is disposed opposite to the second substrate 160. Each of the first substrate 110 and the second substrate 160 may be a rigid substrate such as a glass substrate, a plastic substrate, a quartz substrate or a sapphire substrate, or may be a flexible substrate including such as polyimide (PI) or polyethylene terephthalate (PET), but not limited thereto. In other embodiment, one and the other of the first substrate 110 and the second substrate 160 may be a rigid substrate and a flexible substrate. The in-cell touch display device 100 has a touch display region 102 and a peripheral region 104 disposed at least one outer side of the touch display region 102, the first substrate 110 includes at least one bonding area 114 situated in the peripheral region 104, and the second substrate 160 covers the touch display region 102 at least. In this embodiment, the peripheral region 104 surrounds the touch display region 102, and the two outer sides of the touch display region 102 have the bonding area 114 respectively, but not limited thereto. For example, in a variant embodiment, the bonding area 114 may be disposed at one outer side of the touch display region 102 only, or may be disposed at three outer sides or each of the outer sides of the touch display region 102. In addition, because the second substrate 160 at least covers the touch display region 102, a size of the second substrate 160 is greater than or equal to a size of the touch display region 102, and the size of the second substrate 160 may be smaller than a size of the first substrate 110, but not limited thereto. In a variant embodiment, the size of the second substrate 160 may be equal to the size of the first substrate 110.

The display components 120 are disposed on the first substrate 110 and situated between the first substrate 110 and the second substrate 160, wherein each of the display components 120 may include a thin film transistor (TFT) and a pixel electrode, and the thin film transistor and the pixel electrode are electrically connected to each other. Furthermore, the display components 120 include a plurality of scan lines and a plurality of data lines disposed on the first substrate 110 and situated in the touch display region 102, and the scan lines and the data lines are electrically connected to the thin film transistors. For example, the scan lines are electrically connected to gates of the thin film transistors, the data lines are electrically connected to sources of the thin film transistors, and the pixel electrodes are electrically connected to drains of the thin film transistors.

The touch components 140 and the display medium layer 150 are disposed between the first substrate 110 and the second substrate 160. In this embodiment, the touch components 140 may be disposed between the first substrate 110 and the display medium layer 150, but not limited thereto. In other embodiments, the touch components 140 may be disposed between the display medium layer 150 and the second substrate 160. The touch components 140 include touch electrodes 141 disposed in the touch display region 102 and sensing lines 142 electrically connected to the touch electrodes 141, the touch electrodes 141 are utilized for sensing the fingers or the stylus pens or the like of user, and the sensing lines 142 are utilized for transmitting and/or receiving the touch signals. In addition, the touch electrodes 141 are rectangular for example in this embodiment, but not limited thereto, the touch electrodes 141 also may be triangular, parallelogrammic or the like. Moreover, in this embodiment, the touch electrodes 141 also serve as common electrodes in the display time period of the in-cell touch display device 100. For example, a transparent conductive layer is patterned as a plurality of electrode blocks, and each of the electrode blocks is corresponding to at least one pixel unit. Because the resolution of the touch sensing is usually smaller than the resolution of a displaying picture, each electrode block is usually corresponding to multiple pixel units. The electrode blocks serve as common electrodes in the display time period, and serve as touch electrodes in the touch time period. The touch sensing type of this embodiment is self-capacitance touch sensing, but not limited thereto. In a display time period (also called as a first time period), the touch electrodes 141 of the touch components 140 are utilized as the common electrodes and are supplied with the common voltage to generate electrical field between the common electrodes and the pixel electrodes to display images. And, in a touch time period (also called as a second time period), the touch electrodes 141 are used for touch sensing, and utilized for sensing the touch action and the touch position of user. The display time period and the touch time period are not overlapped, but not limited thereto. In a variant embodiment, the touch electrodes 141 may be used for touch sensing only, that is to say, the touch electrodes 141 are formed in a conductive layer different from the common electrodes, and the touch electrodes 141 may be designed as self-capacitance touch sensing or mutual-capacitance touch sensing according to the requirement. On the other hand, in this embodiment, the in-cell touch display device 100 may further include an insulation layer 130 disposed between the touch electrodes 141 and the display components 120, so as to separate the touch electrodes 141 and the display components 120.

In this embodiment, the display medium layer 150 is disposed on the touch components 140, that is to say, both the display components 120 and the touch components 140 are disposed between the display medium layer 150 and the first substrate 110, but not limited thereto. In other embodiment, the touch components 140 may be disposed on the second substrate 160, and the display medium layer 150 may be disposed between the display components 120 and the touch components 140. In addition, in this embodiment, the display medium layer 150 may be a liquid crystal layer, but not limited thereto. In other embodiments, the display medium layer 150 may be an electrophoretic display or an organic light emitting layer.

The connection pads 170 are disposed in the bonding areas 114 of the first substrate 110, at least a portion of the connection pads 170 are electrically connected to the display components 120 (such as the scan lines and the data lines) and touch components (such as the touch electrodes 141 and the sensing lines 142) in the touch display region 102 through conductive lines in the peripheral region 104. As shown in FIG. 1a, the connection pads 170 of this embodiment include a plurality of first connection pads 170a, a plurality of second connection pads 170b and a plurality of third connection pads 170c, wherein the second connection pads 170b are electrically connected to the sensing lines 142 respectively, that is, the second connection pads 170b are electrically connected to the touch electrodes 141 through the sensing lines 142, the first connection pads 170a situated at the lower outer side of the touch display region 102 are electrically connected to the data lines respectively, and the third connection pads 170c situated at the right outer side of the touch display region 102 are electrically connected to the scan lines respectively. In other words, each of the touch electrodes 141 is electrically connected to the corresponding second connection pad 170b, each of the data lines is electrically connected to the corresponding first connection pad 170a, and each of the scan lines is electrically connected to the corresponding third connection pad 170c. Each of at least some of the first connection pads 170a, at least some of the second connection pads 170b and at least some of the third connection pads 170c has a bonding part 172 and an extension part (also called a non-bonding part or a testing part) 174 which are coupled with each other. In this embodiment, each of the first connection pads 170a, the second connection pads 170b and the third connection pads 170c has a bonding part 172 and an extension part 174, but not limited thereto. The bonding parts 172 of the first connection pads 170a, the second connection pads 170b and the third connection pads 170c may be also called as the first bonding parts, the second bonding parts and the third bonding parts, respectively, and the extension parts 172 of the first connection pads 170a, the second connection pads 170b and the third connection pads 170c may be also called as the first extension parts, the second extension parts and the third extension parts, respectively. The bonding parts 172 are utilized for being bonded with and electrically connected to the integrated circuit chips 180, 190, and the extension parts 174 are utilized for being in contact with and electrically connected to the conductive pins (also called as probe needles) used for testing. Therefore, the extension parts 174 are also called testing parts. In the connection pad 170 having the bonding part 172 and the extension part 174 coupled thereto, the area of the bonding part 172 is preferably smaller than an area of the extension part 174, and therefore, when the conductive pins are aligned and in contact with the corresponding first to third connection pads 170a, 170b and 170c for testing the in-cell touch display device, the alignment can be easier and the conductive pins can be in contact with the corresponding connection pads precisely due to the greater area of the extension part 174. The material of the connection pads 170 may include one or more metal material and/or transparent conductive material, for example, the connection pads 170 may be a single layer structure formed from the metal material or the transparent conductive material, or the connection pads 170 may be a multi-layers stacked structure having the metal layers or a multi-layers stacked structure having the metal layer and the metal oxide layer (such as ITO), but not limited thereto. The material of the bonding parts 172 and the material of the extension parts 174 may be the same, and fabricated from the material that is the same as the metal lines and/or the transparent electrodes on the first substrate 110. In this embodiment, the bonding part 172 and the extension part 174 are rectangular, but not limited thereto, the shapes of the bonding part 172 and the extension part 174 may be squares, rectangles, circles, triangles, polygons or the combination of above shapes, but not limited thereto. Because the area of the bonding part 172 is smaller than the area of the extension part 174 in the connection pad 170, a width of the bonding part 172 may be preferably smaller than or equal to a width of the extension part 174. In this embodiment, the width of the bonding part 172 is smaller than the width of the extension part 174, such that the connection pad 170 is formed in a shape of “ [symbol] ”. Moreover, in a variant embodiment, the bonding part 172 may be situated below the extension part 174, and the width of the bonding part 172 is smaller than the width of the extension part 174, such that the connection pad 170 is formed in a shape of “ [symbol] ”. In addition, the area of the bonding part 172 may range from about 600 to about 3000 μm², and preferably may range from about 1500 to about 2500 μm², but not limited thereto. The area of the extension part 174 may range from about 8000 to about 20000 μm², preferably may range from about 9000 to about 14000 μm², and more preferably may be about 10000 μm², but not limited thereto. That is, the area of the extension part 174 is greater than the area of the bonding part 172 in the connection pad 170, so that the extension parts 174 are easy to be in contact with the conductive pins used for testing. The width of the extension part 174 may range from about 12 to about 40 μm, and preferably may range from about 17.5 to about 40 μm. A length of the extension part 174 may range from about 300 to about 1000 μm. For example, the width and length dimension of the extension part 174 may be 17.5 μm×800 μm, 19.5 μm×500 μm, 30 μm×400 μm or 30 μm×300 μm, but not limited thereto. Furthermore, the connection pads 170 of the in-cell touch display device 100 may have different shapes and/or areas.

On the other hand, the in-cell touch display device 100 may further selectively include a plurality of connection pads 170′ disposed in the bonding areas 114 and in the proximity of the outer edge of the first substrate 110. These connection pads 170′ need not to be in contact with the conductive pins when testing the in-cell touch display device, and thus, the connection pads 170′ have bonding parts 172′ only and do not have the extension part utilized for being in contact with the conductive pins used for testing, but not limited thereto. The connection pads 170′ may be utilized to transmit signals to and/or receive signals from a controller printed circuit board (controller PCB). In addition, at least one of the connection pads 170′ may be utilized to receive at least one operating voltage supplied from the controller printed circuit board. For example, the connection pads 170′ are electrically connected to multiple bonding pins disposed on the first substrate 110, and the bonding pins are located in the peripheral region 104 and outside the bonding areas 114, such that at least one flexible printed circuit board electrically connected to the controller PCB may bond with the bonding pins to transmit signals and/or operating voltage. In this embodiment, in the bonding areas 114, the connection pads 170 are arranged in a row or a column along a direction at the side in proximity to the touch display region 102, for example, along a first direction D1 or a second direction D2 which is not parallel to the first direction D1, but not limited thereto. In the connection pads 170 shown in lower outer side of FIG. 1a and arranged along the first direction D1, the first connection pads 170a are disposed between the two second connection pads 170b, that is to say, the second connection pads 170b are disposed at both sides of the first connection pads 170a, but not limited thereto. The locations of the first connection pads 170a and the second connection pads 170b correspond to the locations of the bonding pads of the integrated circuit chip 180 which are predetermined to be bonded with the first connection pads 170a and the second connection pads 170b after testing the in-cell touch display device. In addition, in this embodiment, each of the first connection pads 170a is electrically connected to a corresponding one of the data lines through one of the conductive lines in the peripheral region 104, that is, the first connection pads 170a are electrically connected to the sources of the thin film transistors of the display components 120 respectively, so as to be also called source pads. Each of the second connection pads 170b is electrically connected to a corresponding one of the sensing lines 142 through one of the conductive lines in the peripheral region 104, that is, the second connection pads 170b are electrically connected to the touch electrodes 141 respectively, so as to be also called touch pads. Each of the third connection pads 170c is electrically connected to a corresponding one of the scan lines through one of the conductive lines in the peripheral region 104, that is, the third connection pads 170c are electrically connected to the gates of the thin film transistors of the display components 120 respectively, so as to be also called gate pads. For example, the first connection pads 170a as the source pads are disposed in the bonding area 114 at the lower outer side of the touch display region 102 and arranged in the row extending along the first direction D1, and the third connection pads 170c as the gate pads are disposed in another bonding area 114 at the right outer side of the touch display region 102 and arranged in the column along the second direction D2, but not limited thereto. For example, in a variant embodiment, the third connection pads 170c are disposed in the bonding area 114 at the lower outer side of the touch display region 102 and arranged in the row extending along the first direction D1, the third connection pads 170c are the gate pads, the first connection pads 170a are disposed in another bonding area 114 at the right outer side of the touch display region 102 and arranged in the column along the second direction D2, and the first connection pads 170a are the source pads.

As shown in FIG. 1b and FIG. 2, the integrated circuit chips 180 and 190 have a plurality of bonding pads 182, 182′ and 192, 192′ respectively, and the integrated circuit chips 180, 190 are disposed in the bonding areas 114. In this embodiment, each of the bonding areas 114 has one integrated circuit chip 180 or 190 disposed therein, but not limited thereto, each of the bonding areas 114 may have one or a plurality of the integrated circuit chips 180 or 190 disposed therein, and the integrated circuit chips 180, 190 are electrically connected to the corresponding connection pads 170, 170′. The integrated circuit chips 180, 190 are disposed in the bonding areas 114 of the first substrate 110 by chip on glass (COG) method, that is, when viewed in the direction perpendicular to the first substrate 110, each of the bonding parts 172, 172′ of the connection pads 170, 170′ is overlapped with a corresponding bonding pad 182, 182′, 192 or 192′, and the extension parts 174 of the connection pads 170 are not overlapped with the bonding pads 182, 192. Therefore, the extension parts 174 are also called non-bonding parts. The bonding pads 182, 182′, 192, 192′ may be bonded to the bonding parts 172, 172′ through bonding structures and a conductive adhesive, and the conductive adhesive is situated between the bonding structures and the bonding parts 172, 172′. For example, the bonding structure may be a gold bump or a solder bump, and the conductive adhesive may be an anisotropic conductive film (ACF), but not limited thereto. In this embodiment, the integrated circuit chip 180 situated at the lower outer side of the touch display region 102 includes a source driving circuit and a touch sensing circuit, and the integrated circuit chip 190 situated at the right outer side of the touch display region 102 includes a gate driving circuit, but not limited thereto. The area of each of the bonding pads 182, 192 of integrated circuit chips 180, 190 may approximate the area of the bonding part 172 of the corresponding connection pad 170, and the area of each of the bonding pads 182′, 192′ of integrated circuit chips 180, 190 may approximate the area of the corresponding connection pad 170′. In other words, the area of each of the bonding pads 182, 192 is smaller than the area of the corresponding connection pad 170. Moreover, because the bonding parts 172 are utilized for being bonded with and electrically connected to the integrated circuit chips 180, 190, and the area of the bonding part 172 is smaller than the area of the extension part 174 in the connection pad 170, after the integrated circuit chips 180, 190 are bonded with the corresponding connection pads 170, an area of one portion of the connection pad 170 overlapped with the corresponding bonding pad 182 or 192 is smaller than an area of the other portion of the connection pad 170 not overlapped with the bonding pads 182, 192 when viewed in the direction perpendicular to the first substrate 110. That is to say, an area of one portion of the connection pad 170 bonded with the corresponding bonding pad 182 or 192 is smaller than an area of the other portion of the connection pad 170 not bonded with the bonding pads 182, 192. As shown in FIG. 2, when viewed in the direction perpendicular to the first substrate 110, the extension parts 174 of the connection pads 170 are disposed in the portion of the bonding areas 114 not overlapped with the bonding pads 182, 192 of the integrated circuit chip 180, 190. That is to say, because the extension parts 174 of the connection pads 170 can be disposed in the bonding area 114, so the area of the peripheral region 104 is not increased compared to the prior art, that is, the convenience of test would be increased compared to the prior art, while the area of the border of the in-cell touch display device 100 would not be increased.

The following will continue to disclose the in-cell touch display device test system and the test method of the in-cell touch display device according to the present invention. Note that the in-cell touch display device described in the following is the in-cell touch display device 100 according to the first embodiment of the present invention for an example, but not limited thereto.

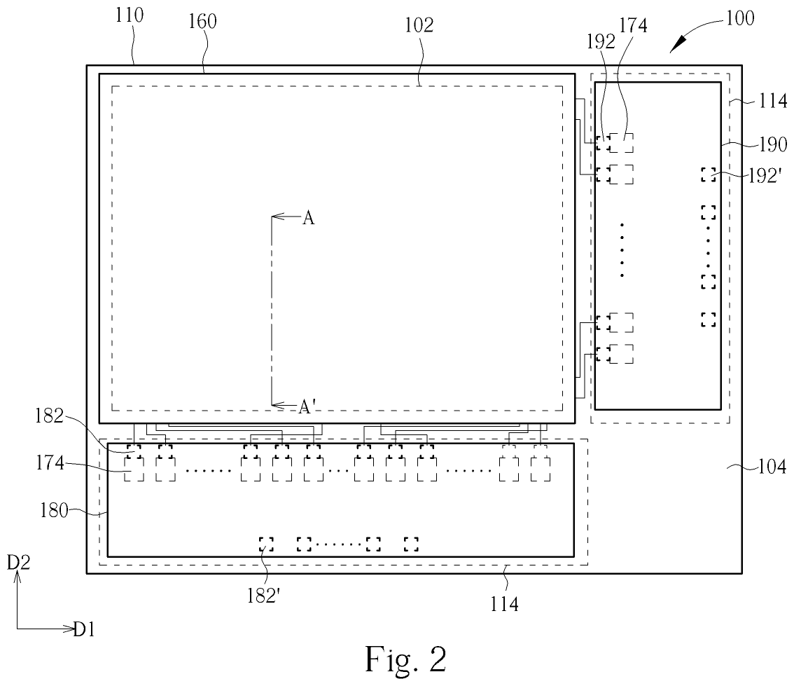

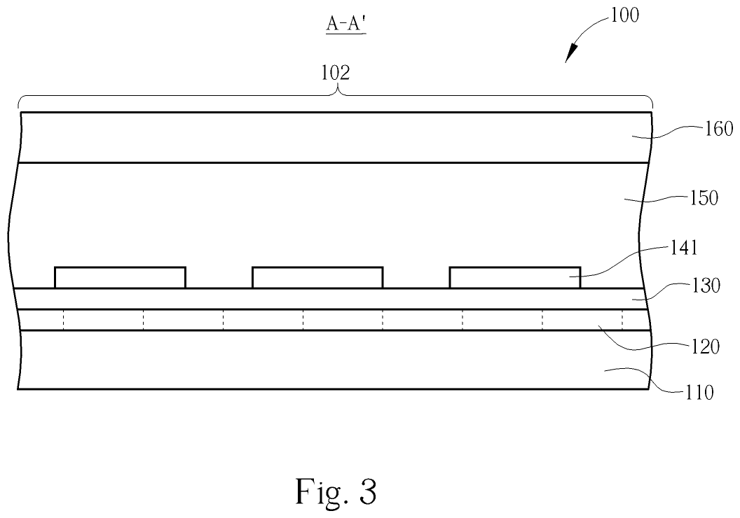

FIG. 4 is a schematic diagram of an in-cell touch display device test system according to an embodiment of the present invention, and FIG. 5 is a schematic diagram of an in-cell touch display device coupled to an in-cell touch display device test system in the testing of the in-cell touch display device according to an embodiment of the present invention. As shown in FIG. 4 and FIG. 5, the in-cell touch display device test system 1000 of this embodiment includes a test plate 1010 and a test circuit board 1020. The test plate 1010 includes a plate body 1014 and a plurality of conductive pins 1012, the conductive pins 1012 are disposed on an under-surface of the plate body 1014, and the test circuit board 1020 and test plate 1010 are electrically connected. For example, the test plate 1010 is electrically connected to the test circuit board 1020 through cables, such that test signals may be provided from the test circuit board 1020 to the conductive pins 1012, but not limited thereto. After completing the manufacture of the display components 120, the touch components 140 and the connection pads 170 of the in-cell touch display device 100, and before electrically connecting the integrated circuit chips 180, 190 to the corresponding connection pads 170, 170′, the test for a touch sensing function and a display function may be performed. When performing the touch-display test to test touch sensing function and the display function of the in-cell touch display device 100, the test plate 1010 is placed on the peripheral region 104 of the in-cell touch display device 100, such that each of at least some of the conductive pins 1012 is correspondingly set to be in contact with a corresponding one of the extension parts 174 of the connection pads 170 of the in-cell touch display device 100. In this embodiment, each of the conductive pins 1012 is correspondingly set to be in contact with a corresponding one of the extension parts 174 of the connection pads 170, but not limited thereto. That is to say, the conductive pins 1012 may be electrically connected to the connection pads 170, such that the test signals provided from the test circuit board 1020 would be transmitted to the scan lines, the data lines and the touch electrodes 141, and the display components 120 and the touch components 140 would be respectively controlled by the test signals provided from the test circuit board 1020, so as to test each of the components independently. In addition, the test plate 1010 is utilized for placing on the peripheral region 104 of the in-cell touch display device 100, and therefore, a shape of the test plate 1010 may correspond to a shape of the peripheral region 104 of the in-cell touch display device 100. So, the test plate 1010 has the shape which is L-shaped, U-shaped or a shape of “ [symbol] ”. In this embodiment, the test plate 1010 has L-shaped.

Moreover, the in-cell touch display device test system 1000 of this embodiment may further include test apparatus 1030. The test apparatus 1030 is electrically connected to the test circuit board 1020, so as to provide at least one voltage and/or at least one signal to the test circuit board 1020. Note that, in some embodiments, the test circuit board 1020 and test apparatus 1030 may be integrated and the test circuit board 1020 is a part of the test apparatus 1030.

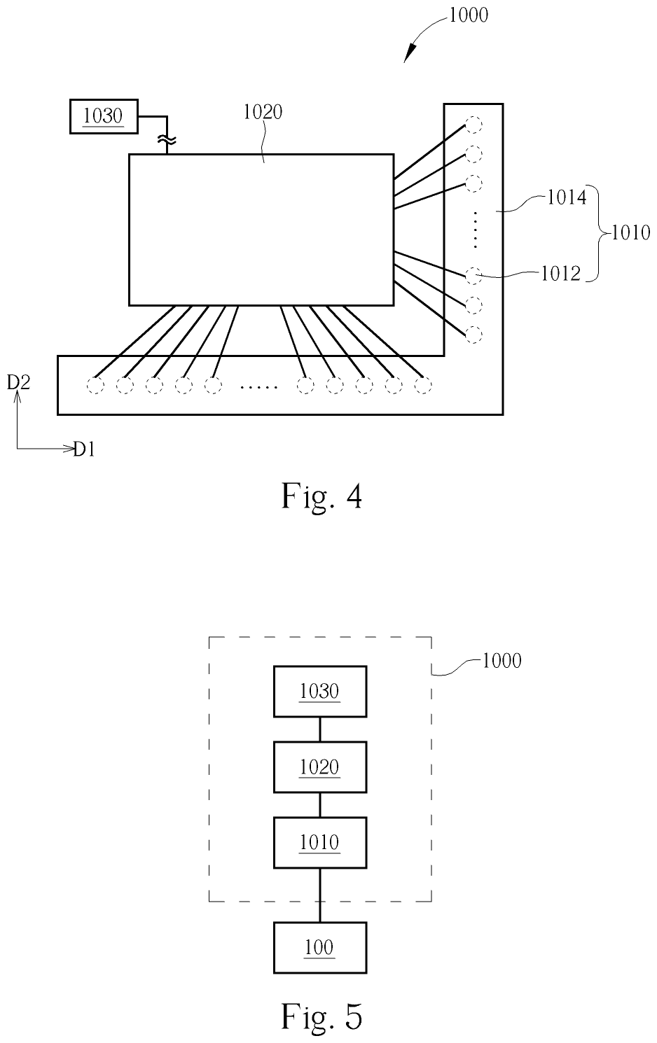

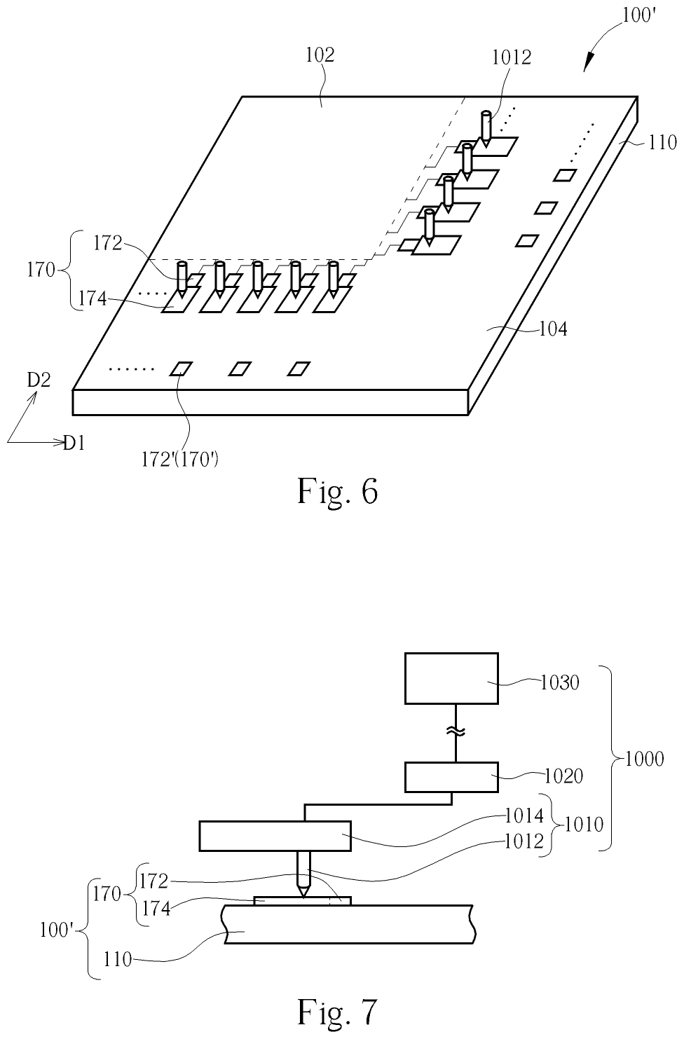

FIG. 6 is a schematic diagram of performing the test of an in-cell touch display device according to a first embodiment of the present invention, and FIG. 7 is a schematic diagram of a cross-sectional view performing the test of the in-cell touch display device according to the first embodiment of the present invention. As shown in FIG. 6 and FIG. 7, firstly, the in-cell touch display device test system 1000 of the present invention and the in-cell touch display device 100′ of the present invention which is to be tested are provided, the in-cell touch display device 100′ includes the components of the in-cell touch display device 100 as showed in FIG. 1a, such as the first substrate 110, the display components 120, the touch components 140 and the connection pads 170, wherein the connection pads 170 are disposed in the bonding areas 114 of the first substrate 110, the connection pads 170 have the bonding parts 172 and the extension parts 174, and the area of the bonding part 172 is smaller than the area of the extension part 174 in the connection pad 170. That is, a structure which is the in-cell touch display device 100 according to the first embodiment of the present invention before disposing the display medium layer 150 and the second substrate 160 on the first substrate 110 and electrically connecting the integrated circuit chip 180, 190 to the connection pads 170, 170′ may be considered as the in-cell touch display device 100′, that is to say, the in-cell touch display device 100 according to the first embodiment may be tested by the in-cell touch display device test system 1000 of the present invention after the touch components 140 and the display components 120 are formed and before the integrated circuit chips 180, 190 are electrically connected to the connection pads 170, 170′. Then, the test plate 1010 would be placed on the peripheral region 104 of the in-cell touch display device 100′, such that each of the conductive pins 1012 is correspondingly set to be in contact with the extension part 174 of one of the connection pads 170 of the in-cell touch display device 100′, so as to make the conductive pins 1012 be electrically connected to the corresponding connection pads 170. Thereafter, the touch-display test is performed, wherein the test circuit board 1020 provides the display components 120 and the touch components 140 with the test signals through the test plate 1010 and the connection pads 170, so as to test the touch sensing function and the display function of the in-cell touch display device 100′.

The conductive pins 1012 of the test plate 1010 are electrically connected to the connection pads 170 respectively such that the conductive pins 1012 are electrically connected to the corresponding scan lines, the corresponding data lines and the corresponding touch electrodes 141, each of the data lines is electrically connected to the corresponding first connection pad 170a, each of the touch electrodes 141 is electrically connected to the corresponding second connection pad 170b, and each of the scan lines is electrically connected to the corresponding third connection pad 170c, so when the test of the in-cell touch display device according to the present invention is performed, each of the first connection pads 170a, each of the second connection pads 170b and each of the third connection pads 170c would be electrically connected to the corresponding conductive pins 1012, and it means as a fully contact test. The in-cell touch display device test system 1000 provides test signals to the first connection pads 170a, the second connection pads 170b and the third connection pads 170c, so as to test the touch sensing function and the display function of the in-cell touch display device 100′ completely. In other words, each of the source pads, each of the touch pads and each of the gate pads would be electrically connected to the corresponding conductive pins 1012 to test the touch sensing function and the display function of the in-cell touch display device 100′ completely. The characteristic of the full contact test according to the present invention is that after manufacturing the touch components 140 and the display components 120 and before electrically connecting the integrated circuit chips 180, 190 to the connection pads 170, 170′, the in-cell touch display device test system 1000 according to the present invention provides the test signals the same as output signals of the integrated circuit chips 180, 190 to the in-cell touch display device 100′, such that the touch sensing function and the display function of the in-cell touch display device 100′ can be tested completely. Therefore, it can judge whether the function of the in-cell touch display device 100′ is normal or not before disposing the integrated circuit chips 180, 190 in the bonding areas 114. In the test of the in-cell touch display device of prior art, the scan lines, the data lines and the sensing lines are respectively divided into two groups according to odd number and even number by shorting bars or switches, or the scan lines and the sensing lines are respectively divided into two groups according to odd number and even number and the data lines divided into three groups according to RGB. And, each of the groups is electrically connected to only one of test pads. Thus, only short circuit test and/or open circuit test of the scan lines, the data lines, the sensing lines and the other components can be performed, and the touch sensing function and the display function of the in-cell touch display device cannot be tested completely. In the present invention, by the full contact test method of the in-cell touch display device 100′, the in-cell touch display device test system 1000 can provide the test signals the same as the output signal of the integrated circuit chips 180, 190 to the in-cell touch display device 100′, so as to perform the touch sensing test and the display test to the in-cell touch display device 100′. For example, in the testing of the in-cell touch display device, the in-cell touch display device test system 1000 provides the first test signals, the second test signals and the third test signals to the first connection pads 170a, the second connection pads 170b and the third connection pads 170c, respectively. The first test signals may include gray-scale signals, the second test signals may include common voltage signals and/or touch driving signals, and the third test signals may include scan signals, but not limited thereto. Therefore, a plurality of functions of the in-cell touch display device may be tested, for example, short circuit, open circuit, color (RGB), gray level, flicker, crosstalk and the like and the touch sensing function can be tested, and the display image with any predetermined pattern can be tested. Moreover, the conductive pins 1012 are electrically connected to the display components 120 (e.g., scan lines, data lines, thin film transistors, pixel electrodes) and the touch components 140 (e.g., touch electrodes 141, sensing lines 142), and thus, the display components 120 and the touch components 140 can be tested independently through the in-cell touch display device test system 1000, such that the touch sensing function and the display function of the in-cell touch display device 100 can be tested independently. In addition, because the touch sensing function and the display function would be tested by the same test system, testing cost and testing time can be economized. Note that the touch electrodes 141 of this embodiment serve as the common electrodes of the in-cell touch display device 100 in the display time period, that is, the touch electrodes 141 are supplied with the common voltage for displaying image in the display time period (also called as the first time period) and used for touch sensing in the touch time period (also called as the second time period), and the first time period and the second time period are not overlapped. Therefore, when the touch-display test is performed, the touch sensing function and the display function need to be tested in different time periods respectively. In other words, the first test signals, a portion of the second test signals (e.g., common voltage signals) and the third test signals are respectively provided to the data lines, the touch electrodes 141 serving as the common electrodes and the scan lines in the first time period, and another portion of the second test signals (e.g., touch driving signals) are provided to the touch electrodes 141 in the second time period, and the first time period and the second time period are not overlapped. For example, each frame of the in-cell touch display device 100 has at least one display time period for displaying image and at least one touch time period for sensing touch; in the display time period, the first connection pads 170a electrically connected to the data lines are supplied with the first test signals such as gray-scale signals, the second connection pads 170b electrically connected to the sensing lines 142 (that is electrically connected to the touch electrodes 141) are supplied with the second test signals such as common voltage signals, and the third connection pads 170c electrically connected to the scan lines are supplied with the third test signals such as scan signals, so as to check if the predetermined image is displayed or not; in the touch time period, the second connection pads 170b electrically connected to the touch electrodes 141 are supplied with the second test signals such as touch driving signals, so as to check the touch sensing function, but not limited thereto. For example, an in-cell touch display device includes M number of data lines (e.g., 1^{st} to M^{th} data lines), N number of scan lines (e.g., 1^{st} to N^{th} scan lines) and K number of sensing lines (e.g., 1^{st} to K^{th} sensing lines), and each of M, N and K is an integer greater than or equal to 4. In the present invention, M, N and K number of connection pads (e.g., M number of first connection pads 170a, N number of third connection pads 170c and K number of second connection pads 170b) are respectively electrically connected to the M number of data lines, the N number of scan lines and the K number of sensing lines, M, N and K number of conductive pins are respectively set to be in contact with the M, N and K number of connection pads, and the first test signals, the third test signals and the second test signals are respectively provided to the M number of data lines, the N number of scan lines and the K number of sensing lines through the M, N and K number of the conductive pins and the M, N and K number of the connection pads, such that each of the M number of data lines receives a corresponding first test signal, each of the N number of scan lines receives a corresponding third test signal, and each of the K number of sensing lines receives a corresponding second test signal. For example, the first test signals may include 1^{st} to M^{th} gray signals, the third test signals may include 1^{st} to N^{th} scan signals, and the second test signals may include common voltage signals and/or 1^{st} to K^{th} touch driving signals, but not limited thereto. Because the in-cell touch display device test system 1000 according to the present invention provides the test signals the same as output signals of the integrated circuit chips, the 1^{st} to N^{th} scan signals are sequentially provided to the 1^{st} to N^{th} scan lines in the testing of the in-cell touch display device, therefore, the enable time (e.g. a time point that the voltage of the scan line is switched from low voltage to high voltage) of the 1^{st} to N^{th} scan lines are different from each other, and the thin film transistors electrically connected to the 1^{st} to N^{th} scan lines are turned on in sequence. In the first time period of the testing of the in-cell touch display device, the first test signals, the second test signals and the third test signals are respectively provided to the data lines, the touch electrodes 141 serving as common electrodes and the scan lines. For example, in the first time period, the 1^{st} to N^{th} scan signals are sequentially provided to the 1^{st} to N^{th} scan lines, the 1^{st} to M^{th} gray signals are respectively provided to 1^{st} to M^{th} data lines, and a common voltage is provided to the 1^{st} to K^{th} sensing lines, such that we can check if an image displayed on the in-cell touch display device is the same as a predetermined image or not, and a display function of the in-cell touch display device is tested. In the second time period of the testing of the in-cell touch display device, the second test signals are provided to the sensing lines. For example, in the second time period, the 1^{st} to K^{th} touch driving signals are provided to 1^{st} to K^{th} sensing lines, and touch sensing signals are feedback to check if a touch sensing function of the in-cell touch display device is normal or not, and the touch sensing function of the in-cell touch display device is tested. Furthermore, in other embodiments, if the in-cell touch display device includes touch electrodes 141 and common electrodes which are made in different conductive layers, the touch sensing function and the display function may be tested in the same time.

Moreover, because the area of the extension part 174 is greater than the area of the bonding part 172 in the connection pad 170, when the conductive pins 1012 of the test plate 1010 correspond to the connection pads 170, it is easy to achieve a precise alignment between the conductive pins 1012 and the corresponding connection pads 170.

On the other hand, the present invention further provides a test method of an in-cell touch display device of a second embodiment. Comparing with the test method of the first embodiment, the test method of the in-cell touch display device of this embodiment is performed after disposing the display medium layer 150 and the second substrate 160 on the first substrate 110 and before electrically connecting the integrated circuit chip 180, 190 to the connection pads 170, 170′, that is to say, a structure which is the in-cell touch display device 100 according to the first embodiment of the present invention before electrically connecting the integrated circuit chip 180, 190 to the connection pads 170, 170′ may be considered as this in-cell touch display device to be tested.

Therefore, with respect to the in-cell touch display device 100, the test method according to the first embodiment may be performed after disposing the display components 120 and the touch components 140 on the first substrate 110 and before assembling the first substrate 110 and the second substrate 160, so as to test the touch sensing function and the display function. Or, the test method according to the second embodiment may be performed after manufacturing the display components 120 and the touch components 140 and assembling the first substrate 110 and the second substrate 160, so as to test the touch sensing function and the display function. Note that the test methods according to the first embodiment and the second embodiment are performed before the steps of electrically connecting the integrated circuit chips 180, 190 to the connection pads 170, 170′.

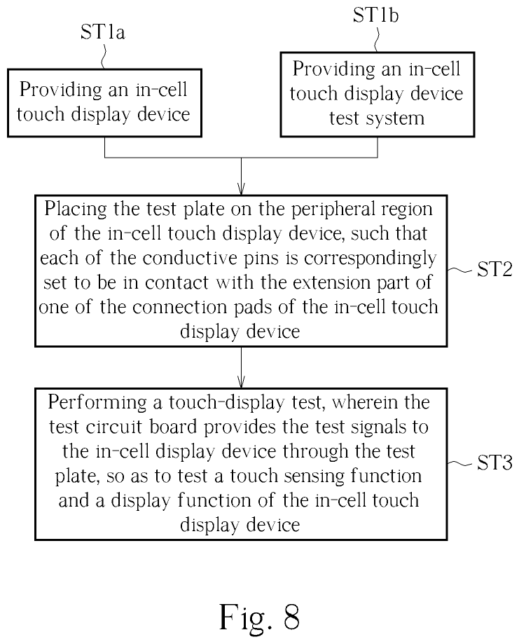

FIG. 8 is a flowchart of the test method of the in-cell touch display device according to an embodiment of the present invention. As shown in FIG. 8, the flowchart of the test method of the in-cell touch display device according to the embodiment of the present invention includes the following steps.

Step ST1a: providing an in-cell touch display device.

Step ST1b: providing an in-cell touch display device test system.

Step ST2: placing the test plate on the peripheral region of the in-cell touch display device, such that each of the conductive pins is correspondingly set to be in contact with the extension part of one of the connection pads of the in-cell touch display device.

Step ST3: performing a touch-display test, wherein the test circuit board provides the test signals to the in-cell display device through the test plate, so as to test a touch sensing function and a display function of the in-cell touch display device.

According to the aforementioned, because the connection pads 170 of the in-cell touch display device 100 according to the present invention have the extension parts 174 of which the area of each is greater than the area of each of the bonding parts 172, the alignment between the conductive pins 1012 and the connection pads 170 would be easy when the conductive pins 1012 of the test plate 1010 correspond to and contact the connection pads 170, so as to avoid the misalignment and shorten the alignment time. On the other hand, because the touch sensing function and the display function would be tested by the in-cell touch display device test system 1000 according to the present invention, the testing cost and the testing time can be economized. Furthermore, the conductive pins 1012 of the in-cell touch display device test system 1000 are electrically connected to the connection pads 170 of the in-cell touch display device 100 respectively, such that the conductive pins 1012 are electrically connected to the corresponding display components 120 and the corresponding touch components 140. Thus, the display components 120 and the touch components 140 can be tested independently through the in-cell touch display device test system 1000, such that the touch sensing function and the display function can be tested completely, and cannot be interfered by each other.

The in-cell touch display device, the in-cell touch display device test system and the test method of the in-cell touch display device of the present invention are not limited to the above embodiments. Further embodiments or variant embodiments of the present invention are described below. To compare each of the embodiments or each of the variant embodiments conveniently and simplify the description, the same component would be labeled with the same symbol in the following. The description just descripts the differences between each of the embodiments, and repeated parts will not be redundantly described.

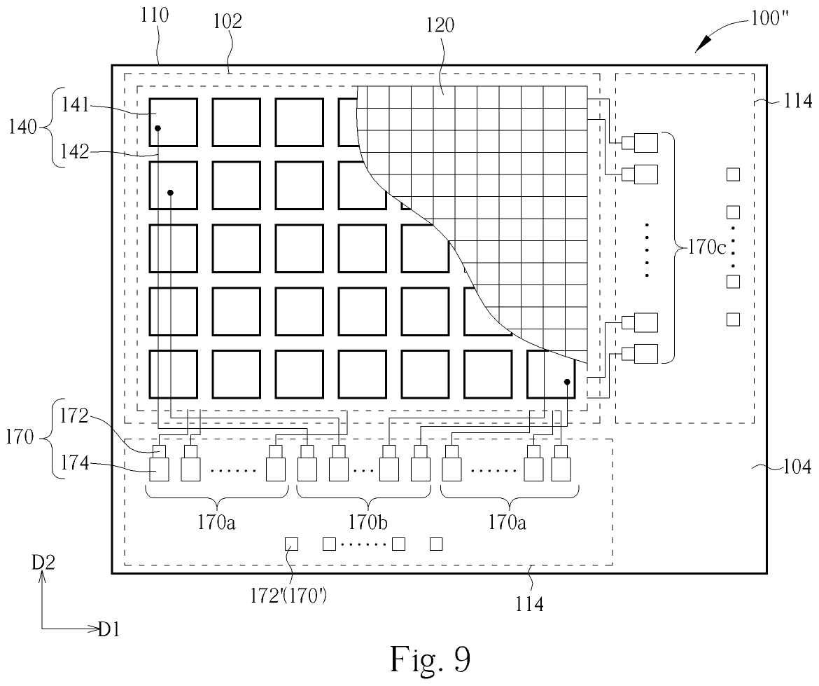

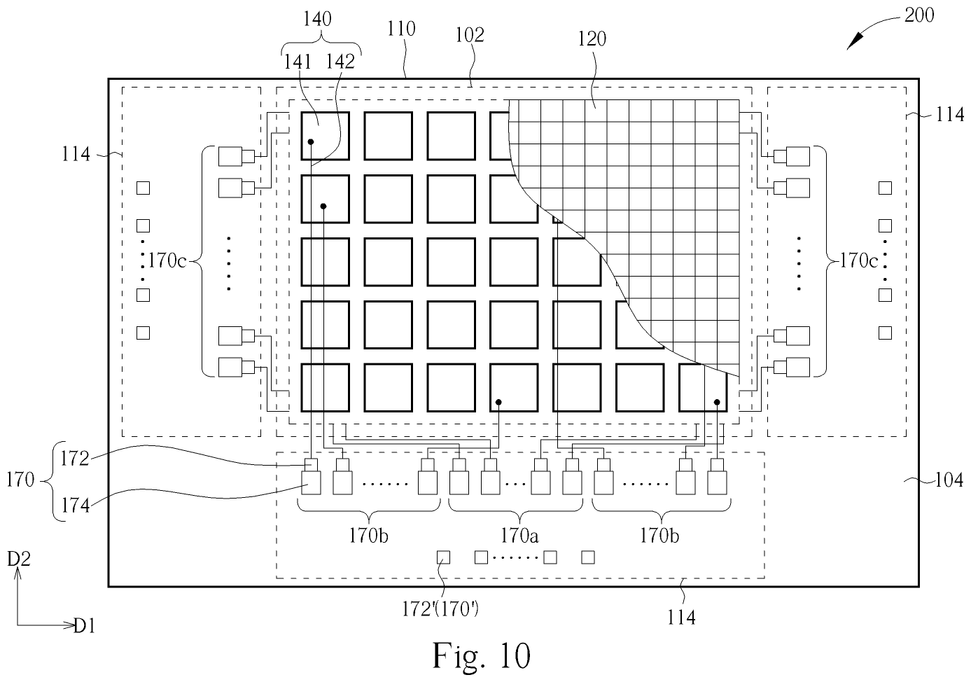

FIG. 9 is a schematic diagram of a top view of an in-cell touch display device according to a variant embodiment of the first embodiment of the present invention, wherein FIG. 9 omits the second substrate and the integrated circuit chip (FIG. 10 to FIG. 13 also omit the second substrate and the integrated circuit chip, and the following will not be redundantly described). Comparing with the first embodiment, in the in-cell touch display device 100″ of this variant embodiment, the connection pads 170 situated at the lower outer side of the touch display region 102 and arranged along the first direction D1 include the first connection pads 170a and the second connection pads 170b, wherein the second connection pads 170b are disposed between two of the first connection pads 170a, that is to say, the first connection pads 170a are disposed at both sides of the second connection pads 170b. In addition, the same as the first embodiment, the first connection pads 170a are the source pads electrically connected to the sources of the thin film transistors of the display components 120, the second connection pads 170b are the touch pads electrically connected to the touch electrodes 141, and the third connection pads 170c are the gate pads electrically connected to the gates of the thin film transistors of the display components 120. For example, the source pads are disposed at the lower outer side of the touch display region 102 and arranged in the row extending along the first direction D1, and the gate pads are disposed at the right outer side of the touch display region 102 and arranged in the column along the second direction D2, but not limited thereto. For example, in another variant embodiment, the third connection pads 170c are disposed in the bonding area 114 at the lower outer side of the touch display region 102 and arranged in the row extending along the first direction D1, the third connection pads 170c are the gate pads, the first connection pads 170a are disposed in another bonding area 114 at the right outer side of the touch display region 102 and arranged in the column along the second direction D2, and the first connection pads 170a are the source pads.

FIG. 10 is a schematic diagram of a top view of an in-cell touch display device according to a second embodiment of the present invention. Comparing with the first embodiment, the in-cell touch display device 200 of this embodiment includes three bonding areas 114 respectively situated at the right outer side, the lower outer side and the left outer side of the touch display region 102 in the peripheral region 104. For example, the first connection pads 170a used as the source pads and the second connection pads 170b used as the touch pads are arranged in the row extending along the first direction D1 in the bonding area 114 situated at the lower outer side of the touch display region 102, and the third connection pads 170c used as the gate pads are arranged in the columns along the second direction D2 in the other two bonding areas 114, but not limited thereto. Moreover, in the in-cell touch display device test system 1000, because the test plate 1010 placed on the peripheral region 104 of the in-cell touch display device 200 corresponds to the bonding area 114, the test plate 1010 corresponding to the in-cell touch display device 200 of this embodiment has the shape which is U-shaped.

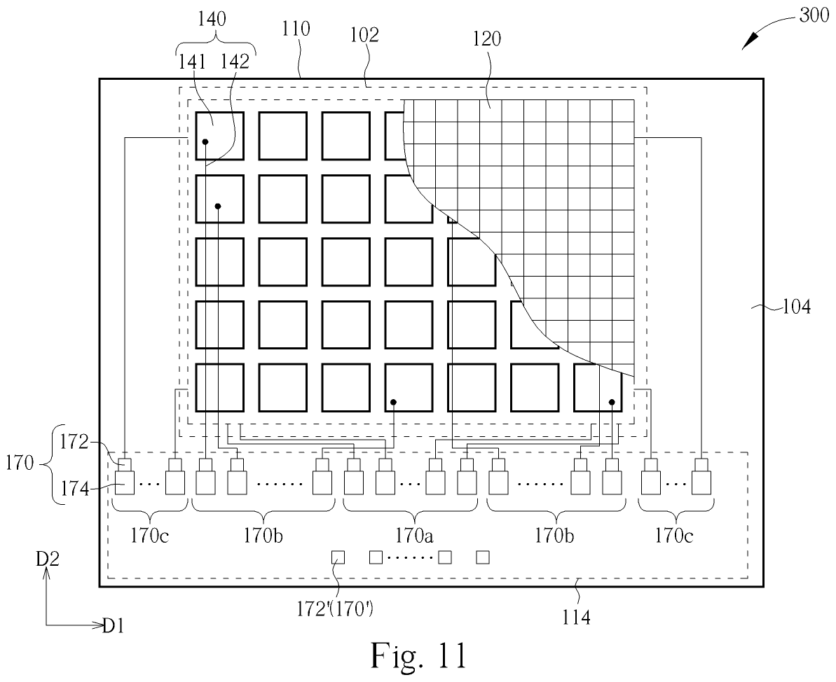

FIG. 11 is a schematic diagram of a top view of an in-cell touch display device according to a third embodiment of the present invention. Comparing with the first embodiment, the bonding area 114 of the in-cell touch display device 300 of this embodiment is disposed at the lower outer side of the touch display region 102. So, all of the first connection pads 170a, all of the second connection pads 170b and all of the third connection pads 170c are arranged in the row extending along the first direction D1 in the bonding area 114. For example, the first connection pads 170a used as the source pads are disposed at the central part of the row and situated between the second connection pads 170b, and the third connection pads 170c used as the gate pads are disposed at the both ends of the row, that is, the second connection pads 170b are situated between the third connection pads 170c and the first connection pads 170a, but not limited thereto. In a variant embodiment, the first connection pads 170a used as the source pads are disposed at the central part of the row and situated between the second connection pads 170b, and the third connection pads 170c used as the gate pads are disposed at one of the ends of the row. In addition, in the in-cell touch display device test system 1000, the test plate 1010 corresponding to the in-cell touch display device 300 of this embodiment has the shape which is a shape of “ [symbol] ”. In this embodiment, the integrated circuit chip (not shown in figure) disposed in the bonding area 114 may include the gate driving circuit, the source driving circuit and the touch sensing circuit, but not limited thereto.

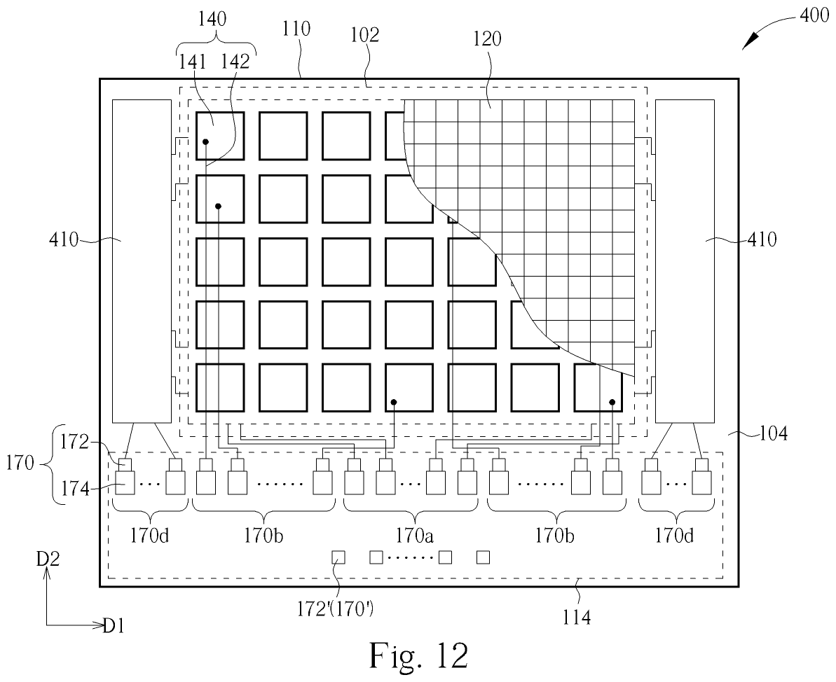

FIG. 12 is a schematic diagram of a top view of an in-cell touch display device according to a fourth embodiment of the present invention. Comparing with the third embodiment, the in-cell touch display device 400 of this embodiment has a gate driver on array (GOA) structure, that is, the in-cell touch display device 400 further includes at least one gate driving circuit 410 disposed on the first substrate 110 and situated between the first substrate 110 and the second substrate 160. In this embodiment, the in-cell touch display device 400 may include two gate driving circuits 410 respectively situated at the right outer side and the left outer side of the touch display region 102 in the peripheral region 104. The gate driving circuits 410 are electrically connected to the scan lines in the touch display region 102. The gate driving circuit 410 includes multi-stages shift registers generating and outputting scan signals to the scan lines in the touch display region 102. In this embodiment, the gate driving circuits 410 include a plurality of thin film transistors, and thin film transistors of the gate driving circuits 410 may be manufactured in the process the same as the thin film transistors of the display components 120. Moreover, the connection pads 170 include a plurality of first connection pads 170a, a plurality of second connection pads 170b and a plurality of fourth connection pads 170d, and each of at least some of the first connection pads 170a, at least some of the second connection pads 170b and at least some of the fourth connection pads 170d has the bonding part 172 and the extension part 174. In this embodiment, each of the first connection pads 170a, the second connection pads 170b and the fourth connection pads 170d has a bonding part 172 and an extension part 174, but not limited thereto. The bonding part 172 is coupled with the extension part 174, and the area of the bonding part 172 is smaller than the area of the extension part 174 in the connection pad 170. The bonding parts 172 are utilized for being bonded with and electrically connected to the integrated circuit chip, the extension parts 174 are utilized for being in contact with and electrically connected to the conductive pins used for testing. The bonding parts 172 and the extension parts 174 of the fourth connection pads 170d may be also called as the fourth bonding parts and the fourth extension parts, respectively. The fourth connection pads 170d are electrically connected to the gate driving circuits 410, so as to be gate driving circuit controlling pads. When the touch-display test is performed, the in-cell touch display device test system 1000 may provide the fourth test signals to the gate driving circuits 410 through the fourth connection pads 170d (some conductive pins 1012 may be correspondingly set to be in contact with the fourth connection pads 170d), so as to control the voltages of the scan lines in the touch display region 102, such that the gate driving circuits 410 and the display components 120 may be tested at the same time. For example, The fourth test signals may comprise the gate driving circuit control signals, and the gate driving circuit control signals may include at least one clock signal, a start signal, an end signal or a combination thereof, but not limited thereto, so as to control the gate driving circuits 410 to output scan signals to the scan lines. For example, in an in-cell touch display device having N number of scan lines, the gate driving circuits 410 sequentially output the 1^{st} to N^{th} scan signals to the 1^{st} to N^{th} scan lines after the start signal is enabled (e.g., the voltage of the start signal is switched from low voltage to high voltage). In this embodiment, the first connection pads 170a may be electrically connected to the sources of the thin film transistors of the display components 120, the gate driving circuits 410 may be electrically connected to the gates of the thin film transistors of the display components 120 and control the gate voltages of the thin film transistors of the display components 120 through the scan signals, but not limited thereto. In the testing of the in-cell touch display device of this embodiment, and an in-cell touch display device includes M number of data lines (e.g., 1^{st} to M^{th} data lines), N number of scan lines (e.g., 1^{st} to N^{th} scan lines), K number of sensing lines (e.g., 1^{st} to K^{th} sensing lines) and P number of circuit control signal lines (e.g., 1^{st} to P^{th} control signal lines) which are electrically connected to the gate driving circuits 410, each of M, N and K is an integer greater than or equal to 4, and P is an integer greater than or equal to 2. In the present invention, M, P and K number of connection pads (e.g., M number of first connection pads 170a, P number of fourth connection pads 170d and K number of second connection pads 170b) are respectively electrically connected to the M number of data lines, the P number of circuit control signal lines and the K number of sensing lines, M, P and K number of conductive pins are respectively set to be in contact with the M, P and K number of connection pads, and the first test signals, the fourth test signals and the second test signals are respectively provided to the M number of data lines, the P number of circuit control signal lines and the K number of sensing lines through the M, P and K number of the conductive pins and the M, P and K number of the connection pads, such that each of the M number of data lines receives a corresponding first test signal, each of the P number of circuit control signal lines receives a corresponding fourth test signal, and each of the K number of sensing lines receives a corresponding second test signal. For example, the first test signals may include 1^{st} to M^{th} gray signals, the fourth test signals may include 1^{st} to P^{th} gate driving circuit control signals, and the second test signals may include common voltage signals and/or 1^{st} to K^{th} touch driving signals, but not limited thereto. Because the in-cell touch display device test system 1000 according to the present invention provides the test signals the same as output signals of the integrated circuit chips, the 1^{st} to P^{th} gate driving circuit control signals are provided to the 1^{st} to P^{th} circuit control signal lines in the testing of the in-cell touch display device, such that the gate driving circuits 410 sequentially output the 1^{st} to N^{th} scan signals to the 1^{st} to N^{th} scan lines, therefore, the enable time (e.g. a time point that the voltage of the scan line is switched from low voltage to high voltage) of the 1^{st} to N^{th} scan lines are different from each other, and the thin film transistors electrically connected to the 1^{st} to N^{th} scan lines are turned on in sequence. In the first time period of the testing of the in-cell touch display device, the first test signals, the second test signals and the fourth test signals are respectively provided to the data lines, the touch electrodes 141 serving as the common electrodes and the scan lines. For example, in the first time period, the 1^{st} to P^{th} gate driving circuit control signals are respectively provided to 1^{st} to P^{th} circuit control signal lines, the 1^{st} to M^{th} gray signals are respectively provided to 1^{st} to M^{th} data lines, and a common voltage is provided to the 1^{st} to K^{th} sensing lines, such that we can check if an image displayed on the in-cell touch display device is the same as a predetermined image or not, and a display function of the in-cell touch display device is tested. In the second time period of the testing of the in-cell touch display device, the second test signals are provided to the sensing lines. For example, in the second time period, the 1^{st} to K^{th} touch driving signals are provided to 1^{st} to K^{th} sensing lines, and touch sensing signals are feedback to check if a touch sensing function of the in-cell touch display device is normal or not, and the touch sensing function of the in-cell touch display device is tested. In addition, the first connection pads 170a, the second connection pads 170b and the fourth connection pads 170d of the connection pads 170 are arranged in the row extending along the first direction D1 in the bonding area 114. For example, the first connection pads 170a are disposed between two of the second connection pads 170b, and the first connection pads 170a and the second connection pads 170b are disposed between two of the fourth connection pads 170d, but not limited thereto. In a variant embodiment, the gate driving circuits 410 may be only disposed at one of the outer sides of the touch display region 102 in the peripheral region 104, the first connection pads 170a, the second connection pads 170b and the fourth connection pads 170d are arranged in the row extending along the first direction D1, the first connection pads 170a are disposed between two of the second connection pads 170b, and the fourth connection pads 170d are only disposed at one of the ends of the row. Moreover, in another variant embodiment, the fourth connection pads 170d may be situated at the side of the bonding area 114 near the edge of the first substrate 110, that is, the fourth connection pads 170d are not in the row having the first connection pads 170a and the second connection pads 170b. In this embodiment, the integrated circuit chip (not shown in figure) disposed in the bonding area 114 may include the source driving circuit and the touch sensing circuit, and may provide the gate driving circuit control signal to the gate driving circuits 410, but not limited thereto.

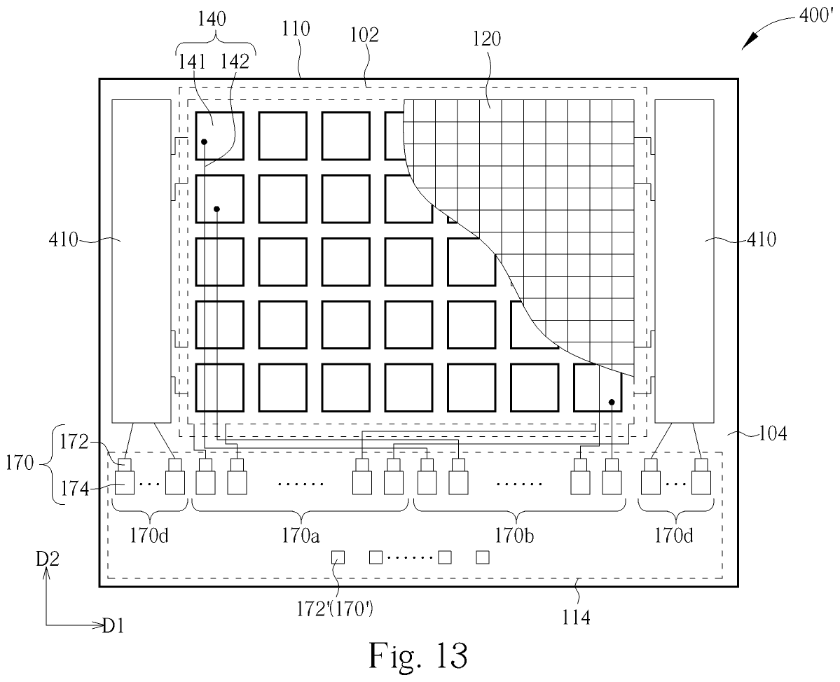

FIG. 13 is a schematic diagram of a top view of an in-cell touch display device according to a variant embodiment of the fourth embodiment of the present invention. Comparing with the fourth embodiment, in the arrangement of the connection pads 170 of the in-cell touch display device 400′ of this embodiment, the second connection pads 170b are disposed at one side of the first connection pads 170a, such as the right side, and the first connection pads 170a and the second connection pads 170b are disposed between two of the fourth connection pads 170d.

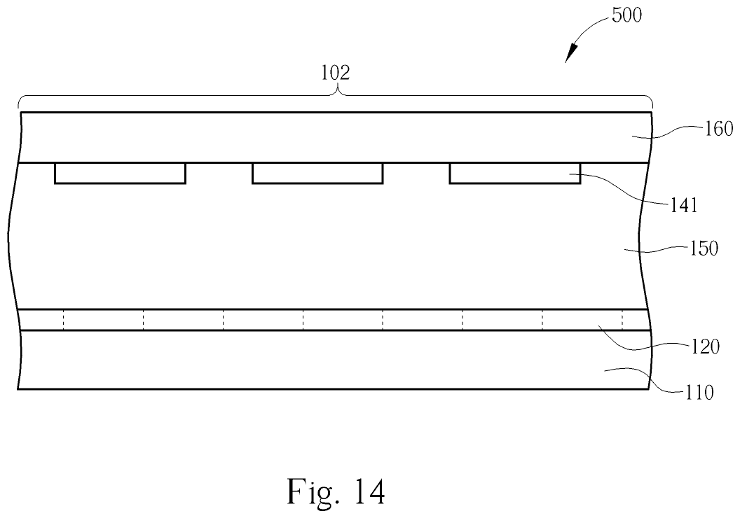

FIG. 14 is a schematic diagram of a top view of an in-cell touch display device according to a fifth embodiment of the present invention. Comparing with the first embodiment, the touch electrodes 141 and the sensing lines (not shown in figure) of the in-cell touch display device 500 of this embodiment are disposed on a surface of the second substrate 160 facing the display medium layer 150, that is, the touch components 140 are disposed between the display medium layer 150 and the second substrate 160. In this embodiment, the touch components 140 are electrically connected to the second connection pads 170b on the first substrate 110 through a conductive adhesive or a sealant having conductive particles, but not limited thereto. Moreover, because the touch components 140 of this embodiment are disposed on the second substrate 160, after assembling the first substrate 110 and the second substrate 160, the test method according to the second embodiment described above may be performed to the in-cell touch display device 500, so as to test the touch sensing function and the display function of the in-cell touch display device 500. The number and the location of the bonding area 114 of in-cell touch display device 500 and the arrangement of the connection pads 170 on the first substrate 110 of in-cell touch display device 500 may refer to the first embodiment to the fourth embodiment and the variant embodiment, and will not be redundantly described.

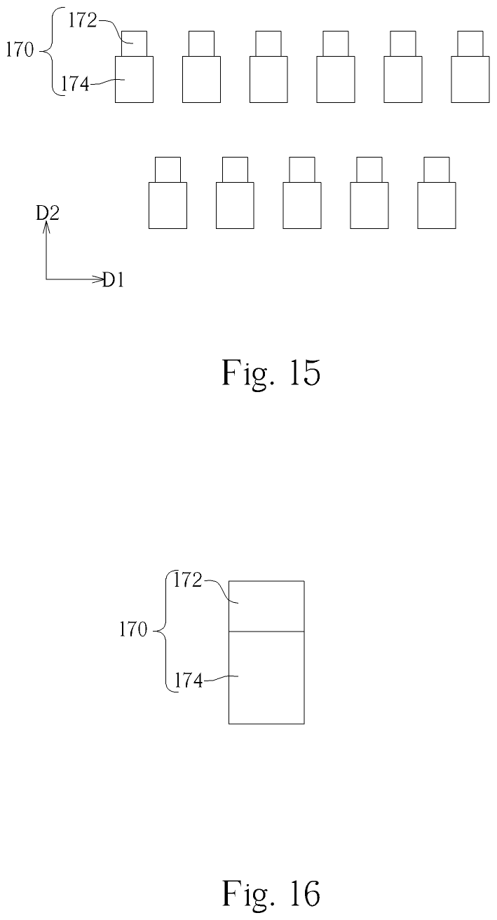

FIG. 15 is a schematic diagram of an arrangement of the connection pads of the in-cell touch display device according to an embodiment of the present invention. The connection pads 170 of this embodiment are arranged extending along the first direction D1 in a plurality of rows, and the rows are arranged along the second direction D2 in parallel, wherein the first direction D1 is not parallel with the second direction D2. In this embodiment, the first direction D1 is perpendicular to the second direction D2, but not limited thereto. In this embodiment, the rows may be arranged with a dislocation in the second direction D2, that is, the connection pads 170 in the different rows are dislocated from each other, such that the connection pads 170 situated in the different rows overlap partially or do not overlap in the second direction D2, but not limited thereto. In addition, the arrangement of the connection pads 170 of this embodiment may be suitable for the in-cell touch display device of each of the embodiments, and the locations of the conductive pins 1012 of the test plate 1010 of the in-cell touch display device test system 1000 may be corresponding to the locations of the connection pads 170.

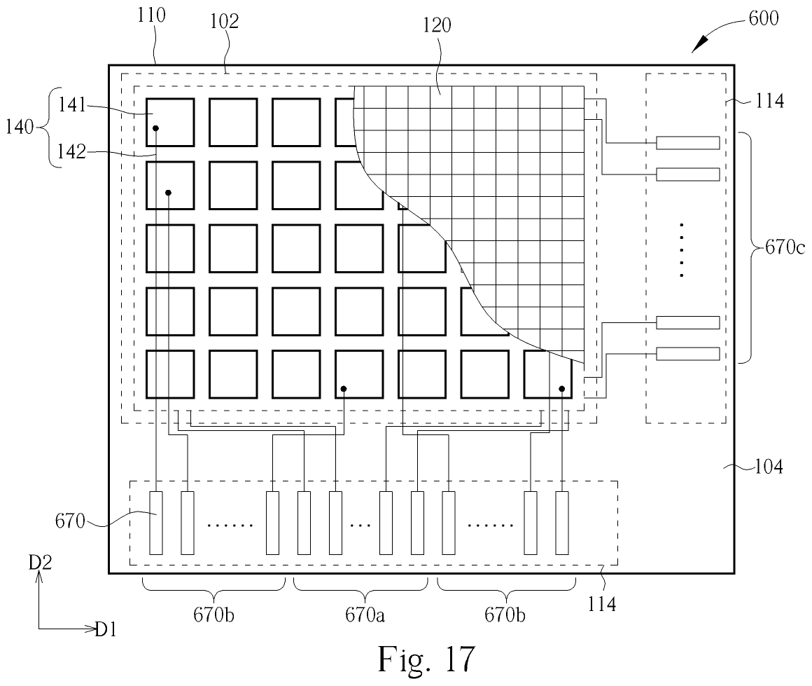

FIG. 16 is a schematic diagram of the connection pads of the in-cell touch display device according to an embodiment of the present invention. The bonding part 172 of the connection pad 170 of this embodiment is coupled with the extension part 174, and the width of the bonding part 172 is equal to the width of the extension part 174, such that the shape of the connection pad 170 is rectangle. The connection pads 170 of this embodiment may be suitable for the in-cell touch display device of each of the embodiments. As shown in FIG. 6, FIG. 15 and FIG. 16, the conductive pins 1012 are in contact with the corresponding extension parts 174 and provide the test signals to the corresponding connection pads 170 in the full contact test, and the bonding part 172 is directly coupled with the extension part 174 in each of the connection pads 170, such that the resistance between the bonding part 172 and the extension part 174 is minimized and the testing signals can be transmitted to the scan lines, data lines and the touch electrodes 141 precisely. In the embodiments shown in FIG. 15 and FIG. 16, the connection pad 170 has the bonding part 172 and the extension part 174 directly coupled with each other, and the width of the bonding part 172 is smaller than or equal to the width of the extension part 174, but not limited thereto. In a variant embodiment, a connection part may be disposed between the bonding part 172 and the extension part 174 for electrically connecting the bonding part 172 and the extension parts 174, the connection pad 170 having the connection part disposed between the bonding part 172 and the extension part 174 may increase the flexibility of the location arrangement of the extension part 174.

In the aforementioned disclosure, note that after performing the full contact test of the in-cell touch display device by the in-cell touch display device test system 1000 of the present invention, the integrated circuit chips 180, 190 are disposed in the bonding area 114 of the first substrate 110 by the COG method, so as to electrically connect the integrated circuit chips 180, 190 to the connection pads 170, 170′, and the connection pads 170 have the bonding parts 172 and the extension parts 174. Owing to the cost consideration of the integrated circuit chips 180, 190, the areas of the bonding pads 182, 192 are preferably as small as possible, so as to prevent from increasing the size of the integrated circuit chips 180, 190. Therefore, if the area of the connection pad 170 approximate the area of the corresponding bonding pad 182 or 192, that is, the connection pad 170 has the bonding part 172 only, alignment between the conductive pins and the connection pads 170 is poor and difficult due to the small area of the connection pad 170. Therefore, when the integrated circuit chips 180, 190 of the in-cell touch display device are electrically connected to the connection pads 170, 170′ by the COG method, if the full contact test of the in-cell touch display device of the present invention is to be performed, each of at least some of the connection pads 170 may preferably further include the extension part 174 coupled to the bonding part 172, the bonding parts 172 are to be bonded to the bonding pad 182, 192 of the integrated circuit chips 180, 190, and the extension parts 174 are to be contacted with the conductive pins 1012, so as to advantage the alignment between the conductive pins 1012 and the connection pads 170, and the conductive pins 1012 can be in contact with the corresponding connection pads 170 precisely.

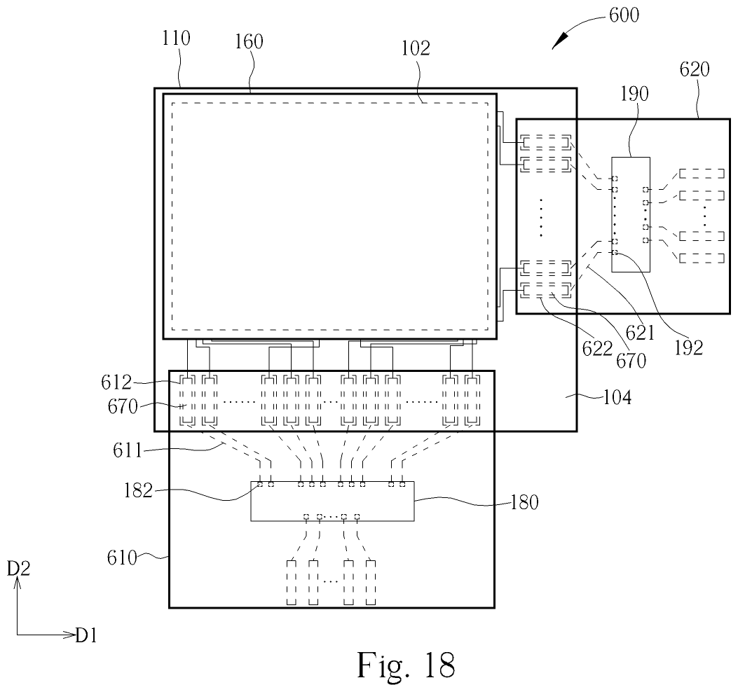

In a variant embodiment, the integrated circuit chip is disposed on a flexible circuit board (such as tape carrier package (TCP) or chip on film (COF)) and conductive leads of the flexible circuit board are electrically connected to the connection pads, such that the integrated circuit chip would be electrically connected to the connection pads through the flexible circuit board. Therefore, in this variant embodiment, after performing the full contact test of the in-cell touch display device through the in-cell touch display device test system 1000 of the present invention, the conductive leads of the flexible circuit board would be electrically connected to the connection pads, such that the integrated circuit chip disposed on the flexible circuit board would be electrically connected to the connection pads. FIG. 17 and FIG. 18 are schematic diagrams of a top view of an in-cell touch display device according to a sixth embodiment of the present invention. FIG. 17 is the schematic diagram of the top view of the in-cell touch display device before disposing the flexible circuit board, the integrated circuit chip and the second substrate, FIG. 18 is the schematic diagram of the top view of the in-cell touch display device after disposing the flexible circuit board, the integrated circuit chip and the second substrate. Comparing with the first embodiment, the difference between FIG. 17 and FIG. 1 is that the connection pads 670 of the in-cell touch display device 600 in FIG. 17 and the connection pads 170, 170′ of the in-cell touch display device 100 in FIG. 1 are different, and the other parts is similar and will not be redundantly described. As shown in FIG. 17 and FIG. 18, the connection pads 670 of this embodiment include a plurality of the first connection pads 670a, a plurality of the second connection pads 670b and a plurality of the third connection pads 670c. Each of the second connection pads 670b is electrically connected to a corresponding one of the sensing lines 142, that is, the second connection pads 670b are electrically connected to the touch electrodes 141 respectively. Each of the first connection pads 670a is electrically connected to a corresponding one of the data lines, and each of the third connection pads 670c is electrically connected to a corresponding one of the scan lines. The integrated circuit chips 180, 190 are disposed on the flexible circuit boards 610, 620 respectively, and the bonding pads 182, 192 of the integrated circuit chips 180, 190 are respectively electrically connected to the conductive leads 612, 622 of the flexible circuit boards 610, 620 through conductive lines 611, 621 of the flexible circuit boards 610, 620. The connection pads 670 are bonded with the conductive leads 612, 622 of the flexible circuit boards 610, 620 for electrically connecting the integrated circuit chips 180, 190. As shown in FIG. 17 and FIG. 18, because the integrated circuit chips 180, 190 are respectively disposed on the flexible circuit boards 610, 620 and electrically connected to the connection pads 670 through the conductive leads 612, 622, and the connection pads 670 are overlapped with and bonded with the conductive leads 612, 622 of the flexible circuit boards 610, 620, such that a size of the connection pad 670 approximates a size of the corresponding conductive lead 612 or 622. Generally the sizes of the conductive leads 612, 622 of the flexible circuit boards 610, 620 are respectively greater than the size of the bonding pads 182, 192 of the integrated circuit chips 180, 190, that is, the area of the connection pad 670 corresponding to the conductive leads 612, 622 in this variant embodiment may be greater than the area of the bonding part 172 corresponding to the bonding pads 182, 192 in the first embodiment. Thus, in this variant embodiment, when the touch sensing function and the display function are tested by the full contact test of the present invention through the in-cell touch display device test system 1000 of the present invention, because the area of the connection pad 670 in this variant embodiment is greater than that of the bonding part 172 in the first embodiment, the conductive pins 1012 may be aligned and in contact with the corresponding connection pads 670 precisely in the full contact test, and the connection pads 670 are overlapped with and bonded with the corresponding conductive leads 612, 622 of the flexible circuit boards 610, 620 after the full contact test is performed. Therefore, the connection pads 670 need not further have the extension parts utilized only for being in contact with the conductive pins 1012 in the full contact test, that is, the connection pad 670 only include the bonding part to be bonded with the corresponding conductive lead 612 or 622 after testing the in-cell touch display device, and the bonding part of connection pad 670 is also used to be in contacted with the corresponding conductive pin 1012 in the full contact test. In this variant embodiment, the connection pad 670 does not include the extension part utilized only for testing. For example, the width and length dimension of the connection pad 670 may be 19.5 μm×1100 μm, 30 μm×400 μm, 33 μm×1050 μm, 30 μm×500 μm or 35 μm×1340 μm, but not limited thereto. In another variant embodiment, the connection pad 670 include the bonding part utilized to be bonded with the corresponding conductive lead 612 or 622 and the extension part utilized to be in contacted with the corresponding conductive pin 1012 in the full contact test, such that when the full contact test method of the in-cell touch display device of the present invention is performed, the alignment of the conductive pins can be easier. Moreover, the connection pads 670 of this embodiment, and the method of electrically connecting the integrated circuit chip and the connection pads after performing the full contact test of the present invention, may be suitable for the in-cell touch display device of each of the embodiments.

To summarize, because the in-cell touch display device of the present invention have the connection pads of which the size is greater comparatively, the misalignment and the alignment time between the conductive pins of the test plate and the corresponding connection pads can be respectively avoided and decreased, so as to increase convenience and accuracy in the test. Also, when the connection pads have the extension parts, the extension part can be disposed in the bonding area, and therefore, in the condition that the area of the peripheral region is not increased and the size of the product and display area are not be changed, the extension parts of the connection pads can be disposed. On the other hand, because the touch sensing function and the display function of the in-cell touch display device would be tested by the test method of the in-cell touch display device and the in-cell touch display device test system according to the present invention, the testing cost and the testing time can be economized. Furthermore, the conductive pins of the test plate of the in-cell touch display device test system are electrically connected to the connection pads of the in-cell touch display device, such that the conductive pins are electrically connected to the corresponding display components and the corresponding touch components. Thus, the display components and the touch components can be tested independently through the in-cell touch display device test system, such that the touch sensing function and the display function can be tested, and cannot be interfered by each other. Moreover, the in-cell touch display device test system according to the present invention provides the test signals the same as output signals of the integrated circuit chip to the in-cell touch display device, such that the touch sensing function and the display function of the in-cell touch display device can be tested by the full contact test method completely. Therefore, it can judge whether the function of the in-cell touch display device is normal or not before electrically connecting the integrated circuit chip to the connection pads.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A test method of an in-cell touch display device, comprising:
providing an in-cell touch display device, wherein the in-cell touch display device has a touch display region and a peripheral region, and the in-cell touch display device comprises:
a first substrate;
a plurality of scan lines and a plurality of data lines disposed on the first substrate and situated in the touch display region;
a plurality of touch electrodes situated in the touch display region; and
a plurality of connection pads disposed on the first substrate and situated in the peripheral region, the connection pads comprising a plurality of first connection pads and a plurality of second connection pads, each of the first connection pads being electrically connected to a corresponding data line, and each of the second connection pads being electrically connected to a corresponding touch electrode; and
performing a test of the in-cell touch display device, wherein the test of the in-cell touch display device comprises providing a plurality of first test signals to the first connection pads and a plurality of second test signals to the second connection pads.

2. The test method of the in-cell touch display device of claim 1, wherein the connection pads further comprise a plurality of third connection pads, each of the third connection pads is electrically connected to a corresponding scan line, and the step of performing the test of the in-cell touch display device further comprises providing a plurality of third test signals to the third connection pads.

3. The test method of the in-cell touch display device of claim 2, wherein the first test signals comprises a plurality of gray-scale signals, and the third test signals comprises a plurality of scan signals.

4. The test method of the in-cell touch display device of claim 3, wherein the second test signals include a plurality of common voltage signals, the first test signals, the third test signals and the common voltage signals are respectively provided to the data lines, the scan lines and the touch electrodes in a first time period.

5. The test method of the in-cell touch display device of claim 4, wherein the second test signals further include a plurality of touch driving signals, and the touch driving signals are provided to the touch electrodes in a second time period.

6. The test method of the in-cell touch display device of claim 5, wherein the first time period and the second time period are not overlapped.

7. The test method of the in-cell touch display device of claim 6, wherein the touch electrodes serve as common electrodes in the first time period.

8. The test method of the in-cell touch display device of claim 1, wherein the in-cell touch display device further comprises at least one gate driving circuit disposed on the first substrate and situated in the peripheral region, the at least one gate driving circuit is electrically connected to the scan lines, the connection pads further comprise a plurality of fourth connection pads electrically connected to the at least one gate driving circuit, and the step of performing the test of the in-cell touch display device further comprises providing a plurality of fourth test signals to the fourth connection pads.

9. The test method of the in-cell touch display device of claim 8, wherein the first test signals comprises a plurality of gray-scale signals, and the fourth test signals comprises a plurality of gate driving circuit control signals.

10. The test method of the in-cell touch display device of claim 9, wherein the gate driving circuit control signals comprises a start signal and at least one clock signal.

11. The test method of the in-cell touch display device of claim 9, wherein the second test signals comprises a plurality of common voltage signals and a plurality of touch driving signals, the first test signals, the fourth test signals and the common voltage signals are respectively provided to the data lines, the at least one gate driving circuit and the touch electrodes in a first time period, and the touch driving signals are provided to the touch electrodes in a second time period.

12. The test method of the in-cell touch display device of claim 11, wherein the first time period and the second time period are not overlapped.

13. The test method of the in-cell touch display device of claim 12, wherein the touch electrodes serve as common electrodes in the first time period.

14. The test method of the in-cell touch display device of claim 1, wherein the in-cell touch display device further comprises a display medium layer.

15. The test method of the in-cell touch display device of claim 14, wherein the display medium layer is a liquid crystal layer, an electrophoretic display layer or an organic light emitting layer.

16. The test method of the in-cell touch display device of claim 14, wherein the in-cell touch display device further comprises a second substrate, and the touch electrodes are situated between the first substrate and the display medium layer or between the display medium layer and the second substrate.

17. The test method of the in-cell touch display device of claim 1, wherein the step of performing the test of the in-cell touch display device further comprises providing a test system, the test system comprises a test plate having a plurality of conductive pins, the test plate is placed on the peripheral region and a portion of the conductive pins are correspondingly set to be in contact with the first connection pads and the second connection pads.

18. The test method of the in-cell touch display device of claim 17, wherein the test plate has a shape which is L-shaped, U-shaped or a shape of “ [symbol] ”.

19. The test method of the in-cell touch display device of claim 17, wherein the connection pads further comprise a plurality of third connection pads, each of the third connection pads is electrically connected to a corresponding scan line, and another portion of the conductive pins are correspondingly set to be in contact with the third connection pads in the step of performing the test of the in-cell touch display device.

20. The test method of the in-cell touch display device of claim 17, wherein the in-cell touch display device further comprises at least one gate driving circuit, the connection pads further comprise a plurality of fourth connection pads, the at least one gate driving circuit is electrically connected to the scan lines and the fourth connection pads, and another portion of the conductive pins are correspondingly set to be in contact with the fourth connection pads in the step of performing the test of the in-cell touch display device.
